(19) United States
(12) Patent Application Publication
(10) Pub. No.: US 2026/0050138 A1
(43) Pub. Date: Feb. 19, 2026

(54) LENS BARREL AND IMAGING DEVICE

(71) Applicant: NIKON CORPORATION, Tokyo (JP)

(72) Inventors: Satoshi YAMADA, Tokyo (JP); Takuji Hamasaki, Tokyo (JP); Takashi Kishimoto, Tokyo (JP)

(73) Assignee: NIKON CORPORATION, Tokyo (JP)

(21) Appl. No.: 19/369,816

(22) Filed: Oct. 27, 2025

Related U.S. Application Data
(63) Continuation of application No. 17/430,590, filed on Aug. 12, 2021, now abandoned.

(30) Foreign Application Priority Data
Feb. 21, 2019 (JP) 2019-029346

(51) Int. Cl. G02B 7/04; G02B 7/02; G03B 17/14

(52) U.S. Cl. CPC G02B 7/04; G02B 7/021; G03B 17/14

(57) ABSTRACT

A lens barrel is provided with: a first tube; a second tube arranged on one side among the radial outside or inside of the first tube and having a linear grove along an optical axis; a fixing member provided to the first tube; a movable member that is movably held by the fixing member and has a first protruding section arranged in the linear groove; and an elastic section arranged between the fixing member and the movable member, wherein the first protruding section abuts against one side surface of the linear groove by means of the elastic section.

### RELATED APPLICATIONS

This application is a continuation of U.S. Patent Application No. 17/430,590, filed August 12, 2021, which is a National Stage Entry of PCT/JP2019/049634, filed December 18, 2019, which claims priority to Japanese Patent Application No. 2019-029346, filed February 21, 2019. The entire contents of each of these applications is incorporated herein by reference.

### TECHNICAL FIELD

The present invention relates to a lens barrel and an imaging device.

### BACKGROUND ART

Looseness in a lens barrel should be prevented. Patent Document 1: Japanese Unexamined Patent Application, Publication No. H07-120651

### DISCLOSURE OF THE INVENTION

A lens barrel of a first aspect is configured to include: a first tube; a second tube arranged on one of an outer side or an inner side of the first tube in a radial direction and including a linear groove along an optical axis; a fixed member provided to the first tube; a moving member retained movably with respect to the fixed member and including a first protrusion arranged in the linear groove; and an elastic part arranged between the fixed member and the moving member, in which the elastic part causes the first protrusion to abut against one side surface of the linear groove.

A lens barrel of a second aspect is configured to include: a first tube; a fixed member provided to the first tube; a moving member retained movably with respect to the fixed member; a second tube including a groove in which the fixed member and the moving member are arranged; and an elastic member arranged between the fixed member and the moving member, in which the elastic member causes the fixed member to abut against one side surface of the groove, and causes the moving member to abut against another side surface of the groove. A lens barrel of a third aspect is configured to include: a first tube; a fixed member provided to the first tube; a moving member retained movably with respect to the fixed member; an elastic member having a biasing force in a circumferential direction around an optical axis, and arranged between the fixed member and the moving member; and a second tube including a groove in which the fixed member, the moving member and the elastic member are arranged.

A lens barrel of a fourth aspect is configured to include: a first tube; a moving member including a first protrusion; a fixed member provided to the first tube, movably retaining the moving member, and including a hole in which the first protrusion is arranged; a second tube including a groove in which the fixed member and the moving member are arranged; and an elastic member arranged between the fixed member and the moving member.

An imaging device of a fifth aspect is configured to include the lens barrel described above.

### BRIEF DESCRIPTION OF THE DRAWINGS

FIG. 1 is a cross-sectional view illustrating a lens barrel 1 of a first embodiment, illustrating a state in which an upper part and a lower part have different focal lengths;

FIG. 2 is a partial perspective view of a linear-travel tube 15 observed from an outer circumferential side, in which a fixed tube 14 positioned at an outer circumference of the linear-travel tube 15 is illustrated with a dotted line;

FIG. 3 is an exploded perspective view of a looseness removing structure 100 illustrated in FIG. 2;

FIG. 4 is a side view illustrating part of a barrel configuration inside a lens barrel 201 of a second embodiment;

FIG. 5 is an exploded view illustrating a state in which a rotationally moving tube 213 is arranged at an outer circumference of a fixed tube 214;

FIG. 6 is a partial perspective view removing the fixed tube 214 from FIG. 4; and

FIG. 7 is an exploded perspective view illustrating a looseness removing structure 250 to be described later, in the state illustrated in FIG. 6.

### PREFERRED MODE FOR CARRYING OUT THE INVENTION

### (First Embodiment)

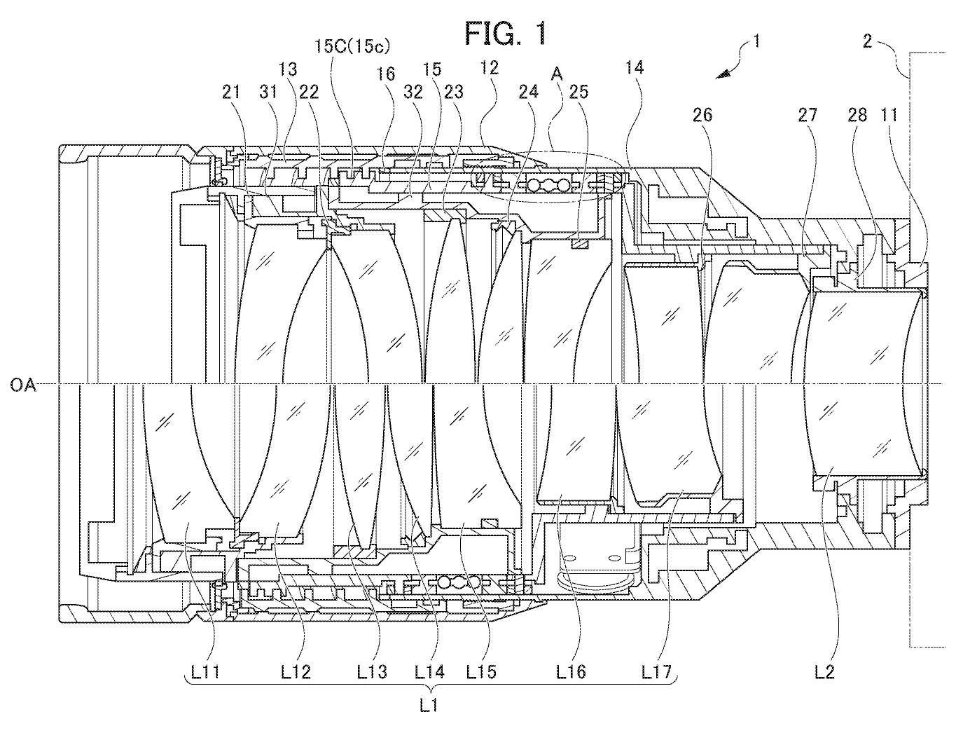

Hereinafter, a lens barrel 1 of a first embodiment will be describe with reference to the drawings, etc. FIG. 1 is a cross-sectional view illustrating the lens barrel 1 of the first embodiment, illustrating a state in which an upper part and a lower part of FIG. 1 have different focal lengths.

The lens barrel 1 has a lens-side mount part 11 on the right side of the drawing and is an interchangeable lens tube 1 attachable/detachable with respect to a body-side mount part (not illustrated) provided to a camera body 2. However, the lens barrel is not limited thereto and may be integral with the camera body 2.

Hereinafter, the left side along an optical axis OA in the drawings is referred to as a subject side, and the right side in the drawings is referred to as an image side.

The lens barrel 1 includes, from the outer circumferential side: a focus ring 12; a rotating tube 13 arranged on the inner circumferential side of the subject side of the focus ring 12 and which rotates integrally with the focus ring 12; a fixed tube 14 arranged on the inner circumferential side of the rotating tube 13 and extending further to the image side than the rotating tube 13; and a linear-travel tube 15 arranged on the inner circumferential side of the rotating tube 13 and the fixed tube 14 and which travels linearly by way of rotation of the rotating tube 13. The fixed tube 14 and the linear-travel tube 15 respectively are non-limiting examples of a second tube and a first tube.

In the present embodiment, the lens barrel 1 is a single-vision lens configured with two units, including a unit-one lens L1 and a unit-two lens L2. However, the lens is not limited to a single-vision lens configured with two units. For example, the lens may be a zoom lens or may be configured with more units.

The unit-one lens L1 includes a first unit-one lens L11, a second unit-one lens L12, a third unit-one lens L13, a fourth unit-one lens L14, a fifth unit-one lens L15, a sixth unit-one lens L16, and a seventh unit-one lens L17. Any unit-one lens L11-L17 may constitute a non-limiting example of a focusing lens.

An outer circumference of the first unit-one lens L11 is retained by a first unit-one lens retaining frame 21, an outer circumference of the second unit-one lens L12 is retained by a second unit-one lens retaining frame 22, an outer circumference of the third unit-one lens L13 is retained by a third unit-one lens retaining frame 23, an outer circumference of the fourth unit-one lens L14 is retained by a fourth unit-one lens retaining frame 24, an outer circumference of the fifth unit-one lens L15 is retained by a fifth unit-one lens retaining frame 25, an outer circumference of the sixth unit-one lens L16 is retained by a sixth unit-one lens retaining frame 26, and an outer circumference of the seventh unit-one lens L17 is retained by a seventh unit-one lens retaining frame 27.

The third unit-one lens retaining frame 23, the fourth unit-one lens retaining frame 24, and the fifth unit-one lens retaining frame 25 are fixed to a second linearly moving tube 32 arranged at the outer circumference thereof. The second linearly moving tube 32 is screwed to the linear-travel tube 15.

Therefore, when the linear-travel tube 15 travels linearly, the second linearly moving tube 32 travels linearly, whereby the third unit-one lens retaining frame 23, the fourth unit-one lens retaining frame 24, and the fifth unit-one lens retaining frame 25 travel linearly, and thus the third unit-one lens L13, the fourth unit-one lens L14, and the fifth unit-one lens L15 travel linearly.

The first unit-one lens retaining frame 21 and the second unit-one lens retaining frame 22 are fixed to the first linearly moving tube 31 arranged at the outer circumference thereof. The first linearly moving tube 31 is screwed at the tip of the subject side of the second linearly moving tube 32.

Therefore, when the linear-travel tube 15 travels linearly, the first linearly moving tube 31 together with the second linearly moving tube 32 travel linearly, whereby the first unit-one lens retaining frame 21 and the second unit-one lens retaining frame 22 travel linearly, and thus the first unit-one lens L11 and the second unit-one lens L12 travel linearly.

The sixth unit-one lens retaining frame 26 and the seventh unit-one lens retaining frame 27 are fixed to the linear-travel tube 15. Therefore, when the linear-travel tube 15 travels linearly, the sixth unit-one lens retaining frame 26 and the seventh unit-one lens retaining frame 27 travel linearly, and thus the sixth unit-one lens L16 and the seventh unit-one lens L17 travel linearly. In other words, the linear-travel tube 15 travels linearly, whereby all the lenses of the unit-one lens L1 travel linearly.

The unit-two lens L2 is retained by a unit-two lens retaining frame 28; and the unit-two lens retaining frame 28 is fixed to the image side of the fixed tube 14.

### (Fixed tube 14)

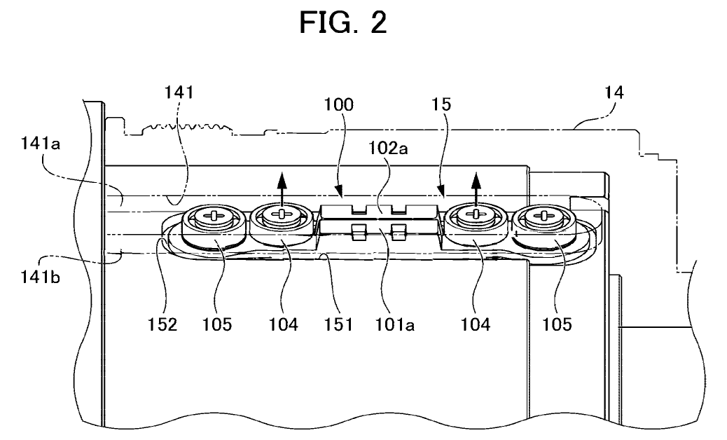

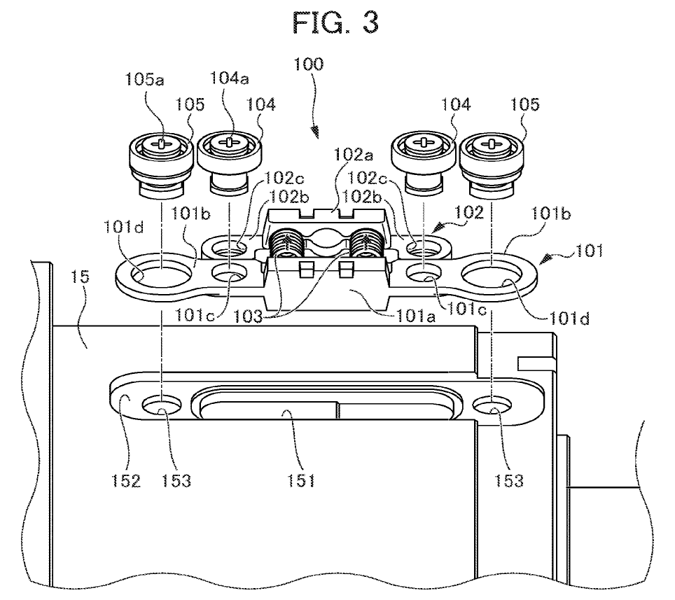

As illustrated in FIG. 1, the fixed tube 14 is a tube member having a larger diameter on the subject side and a smaller diameter on the image side. The fixed tube 14 is not limited to this shape and may have substantially the same diameter on the subject side and the image side. FIG. 2 is a partial perspective view illustrating the linear-travel tube 15 observed from the outer circumferential side, in which the fixed tube 14 positioned at the outer circumference of the linear-travel tube 15 is illustrated with a dotted line. FIG. 3 is an exploded perspective view of a looseness removing structure 100 to be described later in FIG. 2.

"Looseness" refers to relative movement between tube members, caused by manufacturing errors or intentionally provided clearance necessary in assembly at a mechanical design phase. "Looseness removing" means removing this relative movement.

### (Linear-travel tube 15)

As illustrated in FIG. 1, similar to the fixed tube 14, the linear-travel tube 15 has a larger diameter on the subject side and a smaller diameter on the image side, and is provided with a screw part 15C at the end on the subject side, in which the screw part 15C has a further larger diameter than the large-diameter part and is provided with a helicoid screw at an outer circumference. The linear-travel tube 15 is not limited to this shape and may have a shape in which the diameter of the subject side and the image side is substantially the same.

The helicoid screw is screwed into a helicoid groove provided on the inner surface of the subject side of the rotating tube 13; and when the rotating tube 13 rotates, the helicoid screw moves along the helicoid groove. As a result, the linear-travel tube 15 travels linearly (forward or backward) in the optical axis OA direction with respect to the fixed tube 14 as well as the rotating tube 13 that rotates with respect to the fixed tube 14 and does not travel in the optical axis OA direction.

The upper part of FIG. 1 illustrates a state in which the protruding length of the linear-travel tube 15 with respect to the fixed tube 14 is the minimum, in which only the screw part 15C of the linear-travel tube 15 protrudes from the first annular member 16 and the fixed tube 14.

The lower part of FIG. 1 illustrates a state in which the protruding length of the linear-travel tube 15 with respect to the fixed tube 14 is the maximum, in which the screw part 15C of the linear-travel tube 15 is spaced apart from the first annular member 16 and the fixed tube 14 in the optical axis direction, as compared with the state illustrated in the upper part of FIG. 1, and approximately half of the large-diameter part of the linear-travel tube 15 protrudes to the subject side with respect to the first annular member 16 and the fixed tube 14. However, the tip of the linear-travel tube 15 does not protrude from the tip of the rotating tube 13, maintaining the engagement between the helicoid groove of the rotating tube 13 and the helicoid screw of the linear-travel tube 15.

Although only one recess is illustrated in FIGS. 2 and 3, recesses 152 extending in the optical axis OA direction are provided at three positions at equal intervals in the circumferential direction on the outer surface of the linear-travel tube 15. Although only one linear groove is illustrated with a dotted line in FIG. 2, linear grooves 141 are provided at three positions at equal intervals in the circumferential direction on the inner diameter side of the fixed tube 14.

A bottom surface of the recess 152 of the linear-travel tube 15 is provided with a linear hole 151 therethrough. The linear hole 151 is positioned approximately at the center of the recess 152 in the longitudinal direction. Circular openings 153 are provided on both sides of the bottom surface of the recess 152, respectively, sandwiching the linear hole 151. The linear hole 151 may not necessarily be a through hole.

The looseness removing structure 100 is arranged in the recess 152 of the linear-travel tube 15. The looseness removing structure 100 includes: a fixed member 101 extending in the optical axis direction in the recess 152; a moving member 102 extending in the optical axis OA direction in the recess 152 similar to the fixed member 101 but shorter than the fixed member 101; a spring 103 arranged between the fixed member 101 and the moving member 102; two inner bearings 104 protruding to the outer diameter side; and two outer bearings 105 arranged on the outer side of the inner bearings 104 and protruding to the outer diameter side similar to the inner bearing 104. The inner bearing 104 and the outer bearing 105 respectively are non-limiting examples of a first bearing and a second bearing.

### (Fixed member 101)

The fixed member 101 is an elongated member extending in the optical axis OA direction in the recess 152. The fixed member 101 includes: a fixed-side opposing part 101a provided substantially at the center in the longitudinal direction; and fixed-side bearing attaching parts 101b extending in the longitudinal direction from both ends of the fixed-side opposing part 101a. Inner bearing moving long holes 101c and outer bearing fixing holes 101d are provided through the two fixed-side bearing attaching parts 101b, respectively, from the fixed-side opposing part 101a side. Each of the two inner bearing moving long holes 101c is a long hole that is long in the widthwise direction (circumferential direction around the optical axis) of the fixed member 101.

### (Moving member 102)

The moving member 102 is an elongated member extending in the optical axis OA direction in the recess 152 and being shorter than the fixed member 101. The moving member 102 includes a moving-side opposing part 102a at the center in the longitudinal direction. The moving-side opposing part 102a has substantially the same length as the fixed-side opposing part 101a and is arranged so as to oppose the fixed-side opposing part 101a in the circumferential direction.

The moving member 102 includes a moving-side bearing attaching parts 102b extending in the longitudinal direction from both ends of the moving-side opposing part 102a, respectively. Inner bearing fixing holes 102c are provided through the two moving-side bearing attaching parts 102b, respectively.

The moving-side bearing attaching parts 102b are provided closer to the linear-travel tube 15 side (inner diameter side) than the fixed-side bearing attaching parts 101b in the radial direction. In other words, the moving-side bearing attaching parts 102b are arranged between the fixed-side bearing attaching parts 101b and the linear-travel tube 15.

The moving member 102 is arranged in the recess 152 of the linear-travel tube 15; and the fixed member 101 is arranged such that the fixed-side bearing attaching part 101b is arranged on the moving-side bearing attaching part 102b, and the moving-side opposing part 102a and the fixed-side opposing part 101a are opposed to each other.

In this case, the two springs 103 are arranged between the fixed-side opposing part 101a and the moving-side opposing part 102a. The springs 103, each of which may constitute a non-limiting example of an elastic part, are compression springs arranged to extend in the circumferential direction (along the circumferential direction). Specifically, the springs 103 bias the fixed member 101 (fixed-side opposing part 101a) and the moving member 102 (moving-side opposing part 102a) in the circumferential direction.

### (Inner bearing 104)

The distance between the two inner bearing moving long holes 101c in the optical axis OA direction is substantially equal to the distance between the two inner bearing fixing holes 102c in the optical axis direction.

The central shaft 104a of the inner bearing 104 is fixed into the inner bearing fixing hole 102c through the inner bearing moving long hole 101c.

In this case, the outer circumference of the inner bearing 104 protrudes with respect to the moving-side opposing part 102a of the moving member 102 in the circumferential direction.

The inner bearing moving long hole 101c is long hole that is long in the widthwise direction of the fixed member 101; therefore, the inner bearing 104 fixed into the inner bearing fixing hole 102c of the moving member 102 is movable in the longitudinal direction of the inner bearing moving long hole 101c (circumferential direction of the lens barrel). In other words, the inner bearing moving long hole 101c is formed in the shape of a long hole that is long in the circumferential direction of the lens barrel (direction in which the inner bearing 104 and the moving member 102 are movable) such that the inner bearing 104 is movable in the circumferential direction. The inner bearing moving long hole 101c is not limited to a long hole and may be formed such that the inner bearing 104 is movable in the circumferential direction. For example, a notch may be used instead, which is cut out in the widthwise direction of the fixed member 101 (circumferential direction around the optical axis).

### (Outer bearing 105)

The distance between the two outer bearing fixing holes 101d in the optical axis OA direction is equal to the distance between the two openings 153 provided in the recess 152 of the linear-travel tube 15 in the optical axis OA direction.

The central shaft 105a of the outer bearing 105 is attached to the linear-travel tube 15 (opening 153) through the outer bearing fixing hole 101d.

Thus, the outer bearing 105 fixes the fixed member 101 to the linear-travel tube 15.

The fixed member 101 is fixed to the linear-travel tube 15 in this manner. The moving member 102 is movable with respect to the fixed member 101. Therefore, a biasing force of the spring 103 presses the moving member 102 in the circumferential direction of the lens barrel 1 with respect to the fixed-side opposing part 101a, whereby the moving member 102 is movable in the circumferential direction.

The outer circumference of the inner bearing 104 protrudes with respect to the moving-side opposing part 102a of the moving member 102 in the circumferential direction; therefore, the inner bearing 104 abuts against one side surface of the linear groove 141 of the fixed tube 14. The looseness removing mechanism 100 attached to the linear-travel tube 15 travels in the linear groove 141 while the linear-travel tube 15 travels in the optical axis direction. In this case, the inner bearing 104 abuts against the linear groove 141; therefore, the linear-travel tube 15 can smoothly travel without looseness.

The outer circumference of the outer bearing 105 protrudes with respect to the fixed-side opposing part 101a of the fixed member 101 in the circumferential direction. Thus, the outer bearing 105 abuts against the other side surface of the linear groove 141 of the fixed tube 14. Therefore, when the looseness removing mechanism 100 travels in the linear groove 141, the outer bearing 105 abuts against the linear groove 141; therefore, the looseness removing mechanism 100 can suppress looseness and travel smoothly. However, the present invention is not limited thereto, and the outer bearing 105 may be configured not to abut against the linear groove 141.

The moving-side bearing attaching part 102b is sandwiched between the fixed-side bearing attaching part 101b and the linear-travel tube 15; therefore, the moving member 102 can be prevented from floating.

As described above, according to the present embodiment, the outer circumference of the inner bearing 104 abuts against one side surface of the linear groove 141 of the fixed tube 14; and a spring force biases the fixed tube 14 against the linear-travel tube 15 in the circumferential direction. Therefore, looseness in the circumferential direction between the fixed tube 14 and the linear-travel tube 15 that travels linearly with respect to the fixed tube 14 can be removed. By removing looseness using the linear groove 141, looseness between the barrels that do not relatively rotate can be appropriately removed. Optical performance can be improved by removing looseness between the barrels that do not relatively rotate.

The linear-travel tube 15 internally retains the plurality of lens units by way of the second linearly moving tube 32 or the like. By removing looseness in the circumferential direction of the linear-travel tube 15, inclination or looseness of the lens units retained inside the linear-travel tube 15 can be suppressed, and optical performance of the lens barrel 1 can be improved.

In the present embodiment, the looseness removing structure 100 is provided in the three recesses 152 provided at equal intervals in the circumferential direction; however, the present invention is not limited thereto. The looseness removing structure 100 may be provided at two or less positions, or four or more positions. The plurality of recesses 152 and the looseness removing structures 100 may be provided at unequal intervals instead of equal intervals.

The embodiment has described an example, in which the linear-travel tube 15 is arranged on the inner diameter side of the fixed tube 14; however, the linear-travel tube 15 may be arranged on the outer diameter side of the fixed tube 14. In this case, the inner bearing 104 and the outer bearing 104 may protrude to the inner diameter side and may engage with the linear groove 141. In this case, the linear groove 141 is provided on the outer circumferential side of the fixed tube 14.

The embodiment has described an example, in which the outer bearing 105 fixes the fixed member 101 to the linear-travel tube 15; however, a part corresponding to the fixed member 101 may be formed integrally with the linear-travel tube 15.

### (Second Embodiment)

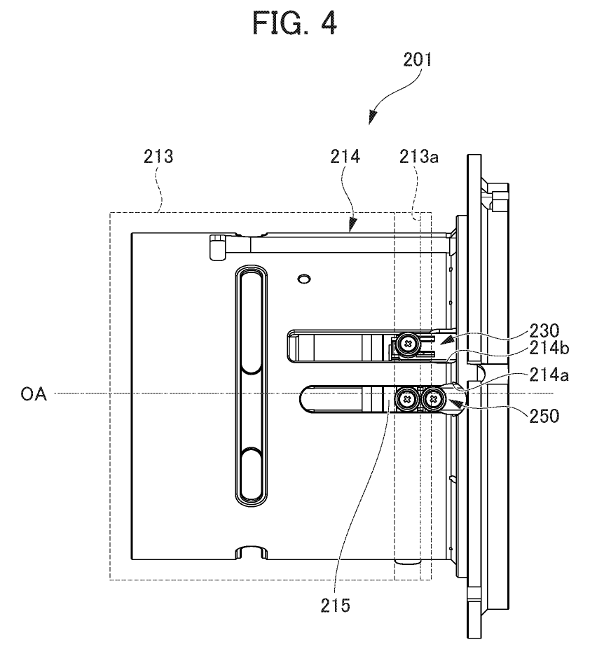

Next, a lens barrel 201 of a second embodiment will be described with reference to the drawings, etc. FIG. 4 is a side view illustrating part of the barrel configuration inside the lens barrel 201 according to the second embodiment. Similar to the lens barrel 1 of the first embodiment, the lens barrel 201 of the second embodiment has a lens-side mount part (not illustrated) and is an interchangeable lens tube 201 attachable/detachable with respect to a camera body (not illustrated). However, the lens barrel 201 is not limited thereto and may be a lens barrel integral with the camera body.

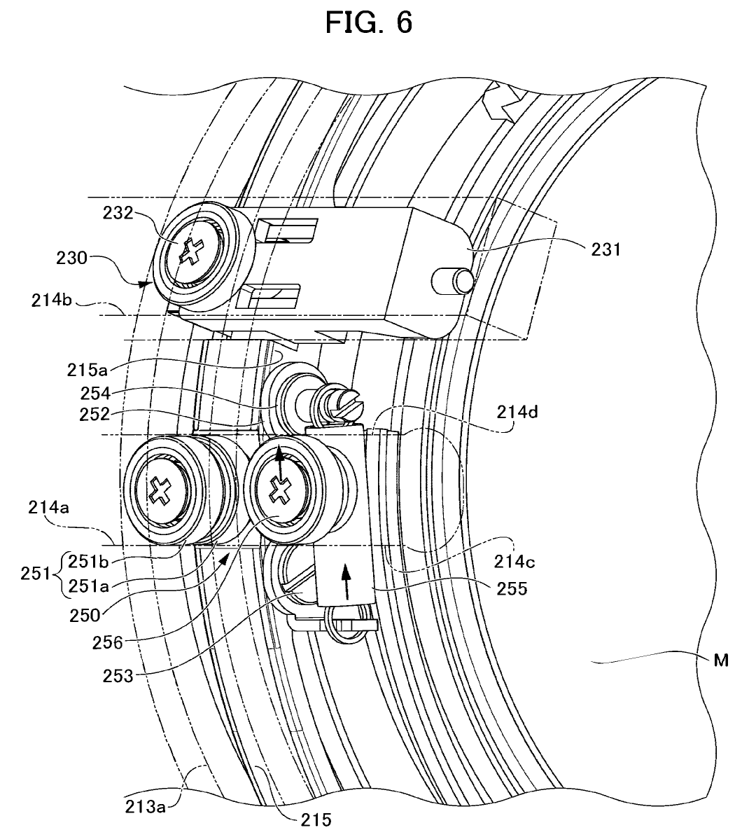

The lens barrel 201 includes at least: a fixed tube 214 illustrated in FIG. 4; a linear-travel tube 215 that is arranged on the inner diameter side of the fixed tube 214, retains a lens unit M (illustrated in FIG. 6), and travels linearly with respect to the fixed tube 214; and a rotationally moving tube 213 (illustrated with a dotted line in FIG. 4) that is arranged on the outer circumferential side of the fixed tube 214, and rotates relative to the fixed tube 214 while moving around the optical axis OA direction.

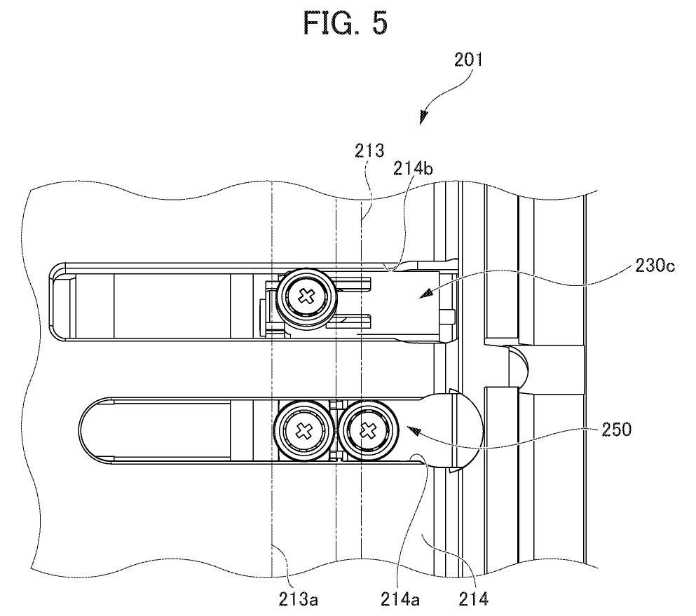

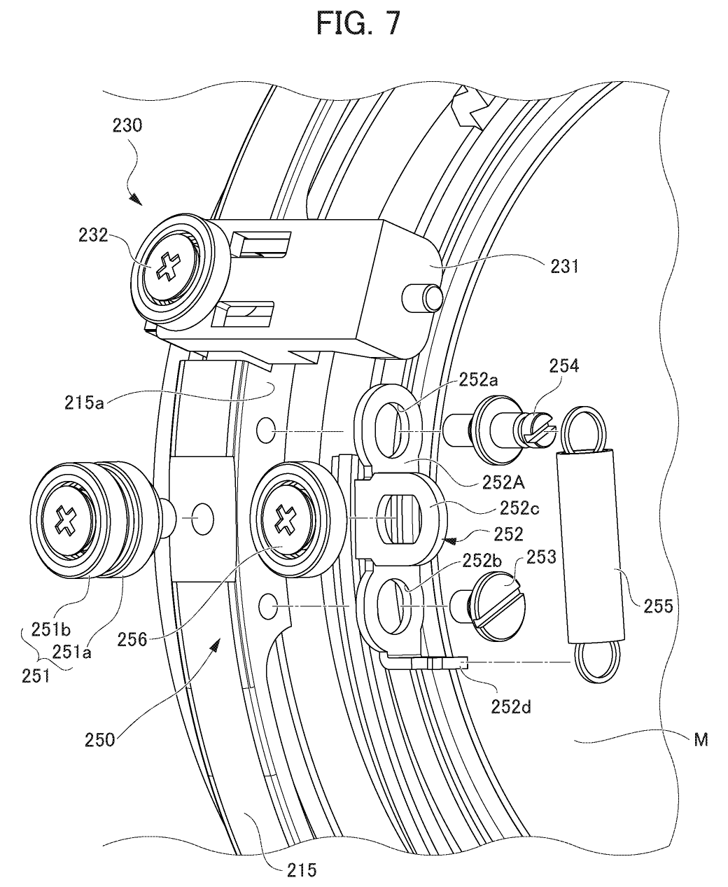

FIG. 5 is an exploded view illustrating a state in which the rotationally moving tube 213 is arranged at the outer circumference of the fixed tube 214. FIG. 6 is a partial perspective view illustrating a state in which the fixed tube 214 is removed from FIG. 4, illustrating the rotationally moving tube 213 and the fixed tube 214 with dotted lines. FIG. 7 is an exploded perspective view illustrating a looseness removing structure 250 to be described later, in the state of FIG. 6.

### (Rotationally moving tube 213)

The rotationally moving tube 213 causes a rotation operation unit (not illustrated) provided to the lens barrel 201 to rotate, whereby the rotationally moving tube 213 rotates around the optical axis OA and moves in the optical axis OA direction. The rotationally moving tube 213 is provided with a circumferential groove 213a extending in the circumferential direction around the optical axis OA.

### (Fixed tube 214)

The fixed tube 214 is provided with a pair of two linear grooves, which are a linear-travel guide groove 214b extending along the optical axis OA and a looseness removing linear groove 214a, at three positions at equal intervals in the circumferential direction, although only one pair is illustrated in the drawings.

### (Linear-travel tube 215)

The linear-travel tube 215 retains the lens unit M and includes a linear-travel guide part 230 and the looseness removing structure 250 at three positions at equal intervals in the circumferential direction (only one position is illustrated in the drawings).

### (Linear-travel guide part 230)

The linear-travel guide part 230 includes a substantially rectangular linear-travel part 231 attached to the outer circumference surface of the linear-travel tube 215 so as to extend in the optical axis OA direction, and a first linear-travel driving bearing 232 fixed so as to protrude to the outer diameter side from the outer surface of the linear-travel part 231. The first linear-travel driving bearing 232 engages with the circumferential groove 213a of the rotationally moving tube 213.

### (Looseness removing structure 250)

The looseness removing structure 250 includes: a two-stage bearing 251 fixed to the outer circumference surface of the linear-travel tube 215 so as to protrude from the outer diameter side; a moving plate 252 attached to a side surface 215a that is orthogonal to the optical axis OA of the linear-travel tube 215; a first fixing pin 253 and a second fixing pin 254 fixed to the side surface 215a of the linear-travel tube 215 through the moving plate 252; a spring 255 biasing the second fixing pin 254 and the moving plate 252; and a pressing bearing 256 fixed to the moving plate 252.

### (Two-stage bearing 251)

The two-stage bearing 251 is a two-stage structure including a fixed bearing 251a on the inner diameter side and a second linear-travel driving bearing 251b on the outer diameter side, and is fixed to the outer circumference surface of the linear-travel tube 215 so as to protrude to the outer diameter side.

The second linear-travel driving bearing 251b and the first linear-travel driving bearing 232 of the linear-travel guide part 230 share substantially the same distance from the optical axis OA in the radial direction, are positioned at the same circumference in the optical axis OA direction, and engage with the circumferential groove 213a of the rotationally moving tube 213.

In the present embodiment, the outer circumference of the fixed bearing 251a does not abut against the side surface of the looseness removing linear groove 214a, but may abut thereagainst, without limitation thereto. In this case, the fixed bearing 251a abuts against the other side surface instead of the side surface of the linear groove 214a, against which the pressing bearing 256 to be described later abuts.

### (Moving plate 252)

As illustrated in FIG. 7, the moving plate 252 includes: a flat part 252A provided with long holes 252a and 252b extending in the longitudinal direction on both sides thereof in the longitudinal direction; a bearing retaining part 252c bending from one side surface between the two long holes 252a and 252b of the flat part 252A at a substantially right angle with respect to the flat part 252A and extending toward the image side; and a spring catching part 252d bending from one end of the flat part 252A in the longitudinal direction at a substantially right angle with respect to the flat part 252A and extending toward the image side similar to the bearing retaining part 252c.

### (First fixing pin 253, second fixing pin 254)

The first fixing pin 253 is inserted into the long hole 252b provided with the spring catching part 252d; and the first fixing pin 253 is fixed to the side surface 215a of the linear-travel tube 215 through the long hole 252b. The second fixing pin 254 is inserted into the other long hole 252a; and the second fixing pin 254 is fixed to the side surface 215a of the linear-travel tube 215 through the long hole 242a. Thus, the moving plate 252 is arranged movably in the circumferential direction, in which the longitudinal direction is along the circumferential direction of the linear-travel tube 215.

### (Spring 255)

The second fixing pin 254 extends longer than the first fixing pin 253 toward the image side in the optical axis OA; and the extension spring 255 is attached between the second fixing pin 254 and the spring catching part 252d.

### (Pressing bearing 256)

The pressing bearing 256 is fixed to the bearing retaining part 252c of the moving plate 252, and protrudes to the outer diameter side with respect to the linear-travel tube 215.

The spring 255 has one end fixed to the second fixing pin 254 fixed to the linear-travel tube 215 and the other end fixed to the spring catching part 252d of the moving plate 252, and pulls the spring catching part 252d, i.e., the moving plate 252, toward the second fixing pin 254 side in the circumferential direction.

In this case, the moving plate 252 is retained movably in the circumferential direction within the range of the length of the long holes 252a and 252b with respect to the linear-travel tube 215, via the first fixing pin 253 and the second fixing pin 254.

Thus, the moving plate 252 moves in the circumferential direction when pulled by the spring 255 in the circumferential direction. As a result, the pressing bearing 256 also moves in the circumferential direction and abuts against the side surface of the looseness removing linear groove 214a of the fixed tube 214.

When the rotation operation unit (not illustrated) provided to the lens barrel 201 is rotated, the rotationally moving tube 213 moves linearly along the optical axis OA direction while rotating around the optical axis OA. In this case, the first linear-travel driving bearing 232 and the second linear-travel driving bearing 251b engage with the circumferential groove 213a provided to the inner circumferential surface of the rotationally moving tube 213. The first linear-travel driving bearing 232 and the second linear-travel driving bearing 251b are fixed to the linear-travel tube 215 that can only travel linearly without rotation. Therefore, even if the circumferential groove 213a rotates, the first linear-travel driving bearing 232 and the second linear-travel driving bearing 251b do not rotate around the optical axis OA.

However, each outer surface of the first linear-travel driving bearing 232 and the second linear-travel driving bearing 251b abuts against the circumferential groove 213a and can rotate around each central axis.

Therefore, the linear-travel tube 215 provided with the first linear-travel driving bearing 232 and the second linear-travel driving bearing 251b can obtain a driving force in the optical axis OA direction, without preventing the circumferential groove 213a, i.e., the rotationally moving tube 213 from rotating in the circumferential direction.

In this case, the linear-travel guide groove 214b provided to the fixed tube 214 guides the linear-travel tube 215 to travel linearly. I

n this case, the pressing bearing 256 attached to the linear-travel tube 215 abuts against the side surface of the looseness removing linear groove 214a of the fixed tube 214, thereby removing looseness between the fixed tube 214 and the linear-travel tube 215 in the circumferential direction. Thus, inclination of the lens unit M of the linear-travel tube 215 can be suppressed, and optical performance of the lens barrel 1 can be improved. Further, by removing looseness using the looseness removing linear groove 214a, looseness between the barrels that do not relatively rotate can be appropriately removed. Optical performance can be improved by removing looseness between the barrels that do not relatively rotate.

The embodiment has described a configuration, in which the linear-travel guide part 230 and the looseness removing structure 250 are provided at three positions at equal intervals in the circumferential direction; however, the present invention is not limited thereto. The linear-travel guide part 230 and the looseness removing structure 250 may be provided at two or less positions, or four or more positions, or may be provided at unequal intervals.

The embodiment has described an example, in which the linear-travel tube 215 is arranged on the inner diameter side of the fixed tube 214; however, the linear-travel tube 215 may be arranged on the outer diameter side of the fixed tube 214. In this case, the two-stage bearing 251 or the pressing bearing 256 may protrude to the inner diameter side and engage with the looseness removing linear groove 214a. The rotationally moving tube 213 may be arranged on the inner diameter side of the fixed tube 214, in which the two-stage bearing 251 or the pressing bearing 256 may engage with the looseness removing linear groove 214a and the circumferential groove 213a.

The embodiment has described an example, in which the second fixing pin 254 is fixed to the linear-travel tube 215; however, a part corresponding to the second fixing pin 254 may be formed integrally with the linear-travel tube 215.

It should be noted that the present invention is not limited to the above-described embodiments, and any combination thereof may be used.

### EXPLANATION OF REFERENCE NUMERALS

L1: unit-one lens; L2: unit-two lens; M: lens unit; OA: optical axis; 1: lens barrel; 13: rotating tube; 14: fixed tube; 15: linear-travel tube; 15C: screw part; 16: first annular member; 100: looseness removing structure; 101: fixed member; 101a: fixed-side opposing part; 101b: fixed-side bearing attaching part; 101c: inner bearing moving long hole; 101d: outer bearing fixing hole; 102: moving member; 102a: moving-side opposing part; 102b: moving-side bearing attaching part; 102c: inner bearing fixing hole; 103: spring; 104: inner bearing; 105: outer bearing; 141: linear groove; 151: linear hole; 152: recess; 153: opening; 201: lens barrel; 213: rotationally moving tube; 213a: circumferential groove; 214: fixed tube; 214a: looseness removing linear groove; 214b: linear-travel guide groove; 215: linear-travel tube; 215a: side surface; 230: linear-travel guide part; 231: linear-travel part; 232: first linear-travel driving bearing; 242a: long hole; 250: structure; 251: two-stage bearing; 251a: fixed bearing; 251b: second linear-travel driving bearing; 252: moving plate; 252A: flat part; 252a: long hole; 252b: long hole; 252c: bearing retaining part; 252d: spring catching part; 253: first fixing pin; 254: second fixing pin; 255: spring; 256: pressing bearing

What is claimed is:

1. A lens barrel, comprising:
a first tube;
a second tube arranged on an outer side or an inner side of the first tube in a radial direction and including a linear groove along an optical axis;
a fixed member fixed to the first tube;
a moving member retained movably with respect to the fixed member;
a first bearing that is moved by the moving member;
a second bearing fixed to the first tube and the fixed member, the second bearing fixing the fixed member in position relative to the first tube by extending through the fixed member and into the first tube; and
an elastic part arranged between opposing parts of the fixed member and the moving member along a circumferential direction around the optical axis, the elastic part biasing the fixed member and the moving member in the circumferential direction, wherein
the elastic part is a spring,
the first bearing and the second bearing engage with the linear groove, which is a single groove, and
the first bearing abuts against one side surface of the linear groove and the second bearing abuts against another side surface of the linear groove opposite the one side surface in the circumferential direction.

2. The lens barrel according to claim 1, wherein
the moving member is movable in the circumferential direction around the optical axis, with respect to the fixed member, and
a biasing force of the elastic part is configured to press the moving member in the circumferential direction around the optical axis, whereby the first bearing abuts against the one side surface of the linear groove.

3. The lens barrel according to claim 1, wherein
the elastic part biases the second bearing to cause the second bearing to abut against the other side surface of the linear groove.

4. The lens barrel according to claim 1, wherein
relative positions of the first tube and the second tube in an optical axis direction change.

5. The lens barrel according to claim 1, wherein
the fixed member includes a hole in which the first bearing is arranged.

6. The lens barrel according to claim 1, wherein
the moving member is arranged closer to an inner circumferential side than the fixed member.

7. The lens barrel according to claim 1, further comrpising a recess on an outer radial surface of the first tube, wherein
the fixed member and the moving member are located within the recess.

8. An imaging device, comprising the lens barrel according to claim 1.

9. A lens barrel, comprising:
a first tube having a focusing lens fixed thereto;
a second tube arranged on an outer side of the first tube in a radial direction and including a linear-travel guide part along an optical axis of the lens barrel; and
a bearing protruding from a fixed member of the first tube, the fixed member retaining the bearing and protruding toward an outer diameter side of the first tube, wherein
the bearing abuts against the linear-travel guide part along a circumferential direction around the optical axis.

10. The lens barrel according to claim 9, wherein
circumferential movement of the first tube with respect to the second tube is restricted by the bearing abutting against the linear-travel guide part.

11. The lens barrel according to claim 10, wherein
relative positions of the first tube and the second tube in an optical axis direction change.

12. The lens barrel according to claim 9, wherein
the fixed member protrudes farther in an optical axis direction than the first tube.

13. An imaging device, comprising the lens barrel according to claim 9.
